(19) United States
(12) Patent Application Publication
(10) Pub. No.: US 2025/0045624 A1
(43) Pub. Date: Feb. 6, 2025

(54) Artificial Intelligence Model Factory

(71) Applicant: International Business Machines Corporation, Armonk, NY (US)

(72) Inventors: Dhavalkumar C. Patel, White Plains, NY (US); Vivek Sharma, Bangalore (IN); Anuradha Bhamidipaty, Yorktown Heights, NY (US); Jayant R. Kalagnanam, Briarcliff Manor, NY (US); Shuxin Lin, White Plains, NY (US); Dhruv Shah, New York, NY (US); Srideepika Jayaraman, White Plains, NY (US)

(21) Appl. No.: 18/362,726

(22) Filed: Jul. 31, 2023

(51) Int. Cl. G06N 20/00

(52) U.S. Cl. CPC G06N 20/00

(57) ABSTRACT

An approach for generating an artificial intelligence system configurable for use with assets. In this approach, a model recipe is selected for generating the artificial intelligence system for use with assets. Recipe parameters specified in the model recipe are identified. A training dataset is created using the model recipe and input data. A set of artificial intelligence models is trained using the training dataset, the recipe parameters, and the model recipe. The training creates artifact models. The artifact models resulting from training are evaluated. The evaluation is used to select a set of the artifact models in the artifacts that form the artificial intelligence system that is configurable for use in assets.

### BACKGROUND

The disclosure relates generally to an improved computer system and more specifically to creating artificial intelligence models.

The field of automated data science (AutoDS) and automated machine learning (AutoML) has significantly helped to increase the adoption of artificial intelligence based solutions in various areas such as healthcare, human resources, and manufacturing industries.

The area of data science involves extracting insights and knowledge from data. This type of information extraction can involve preparing and cleaning data, selecting relevant features, selecting the machine learning model, and fine-tuning the parameters of the machine learning model. Automated data science also includes the automating these and other tasks involved in data science.

Automated machine learning includes automating the process of building and optimizing machine learning models. Automated machine learning can use different algorithms and processes to search for and evaluate machine learning models in their configurations. Automated machine learning can involve identifying model architectures in hyperparameter combinations that increase the performance of a machine learning model for specific dataset and problem. Automated data science and automated machine learning can be used to increase the speed at which machine learning models can be built.

### SUMMARY

According to the illustrative embodiments, one or more of a computer implemented method, a computer system, and computer product generate an artificial intelligence system. A number of processor unit selects a model recipe for generating the artificial intelligence system for use with assets. The number of processor units identifies recipe parameters specified in the model recipe. The number of processor units creates a training dataset using the model recipe and input data. The number of processor units trains a set of artificial intelligence models using the training dataset, the recipe parameters, and the model recipe to create artifact models. The number of processor units evaluates the artifacts models resulting from training the set of artificial intelligence models to form an evaluation. The number of processor units selects a set of the artifact models in the artifacts for the artificial intelligence system using the evaluation. According to other illustrative embodiments, a computer system and a computer program product for generating an artificial intelligence system are provided.

### BRIEF DESCRIPTION OF THE DRAWINGS

FIG. 1 is a block diagram of a computing environment in accordance with an illustrative embodiment;

FIG. 2 is a block diagram of an artificial intelligence environment in accordance with an illustrative embodiment;

FIG. 3 is an illustration of an artificial intelligence model factory in accordance with an illustrative embodiment;

FIG. 4 is an illustration of an artificial intelligence model factory in accordance with an illustrative embodiment;

FIG. 5 is an illustration of a data model in accordance with an illustrative embodiment;

FIG. 6 is a flowchart of a process for generating an artificial intelligence system in accordance with an illustrative embodiment;

FIG. 7 is a flowchart of a process for generating an artificial intelligence system in accordance with an illustrative embodiment;

FIG. 8 is a flowchart of a process for deploying an artificial intelligence system in accordance with an illustrative embodiment;

FIG. 9 is a flowchart of a process for deploying an artificial intelligence system in accordance with an illustrative embodiment;

FIG. 10 is a flowchart of a process for monitoring and artificial intelligence system after deployment in accordance with an illustrative embodiment;

FIG. 11 is a flowchart of a process for training a set of artificial intelligence models in accordance with an illustrative embodiment;

FIG. 12 is a flowchart of a process for training a set of artificial intelligence models in accordance with an illustrative embodiment; and

FIG. 13 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

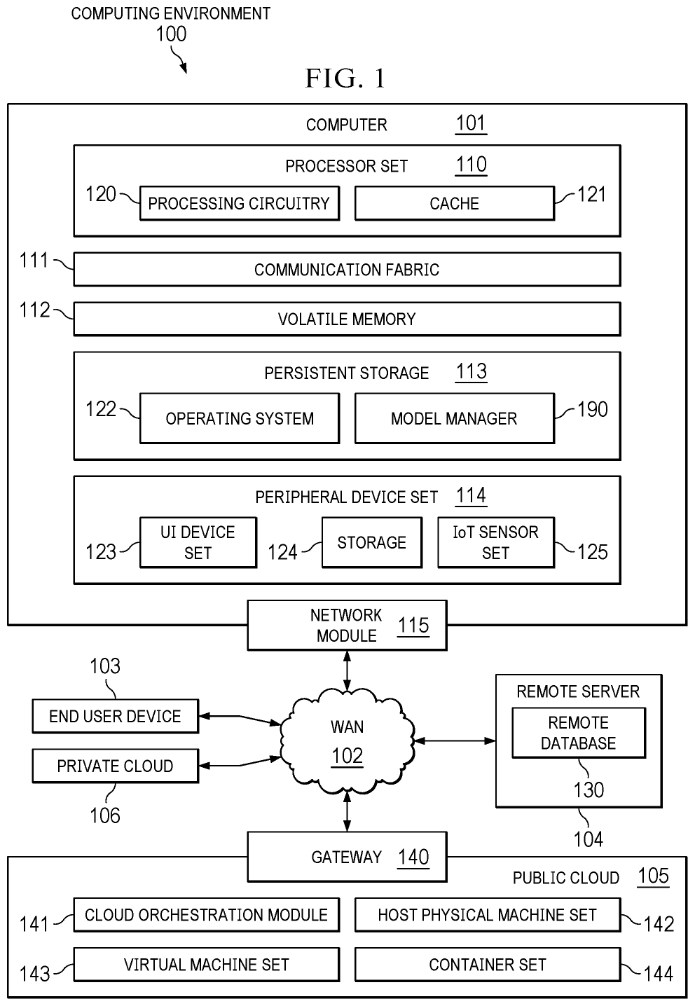

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as model manager 190. In addition to model manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and model manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in model manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in model manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The illustrative examples recognize and take into account a number of different considerations as described herein. For example, artificial intelligence models can be created for use with industrial assets. These industrial assets include, for example, wind turbines. Wind turbines can be located on wind farms. Small windfarms may have several dozen wind turbines while large windfarms may have hundreds or thousands of wind turbines.

Further, wind turbines on a windfarm can be heterogeneous. In other words, different types of wind turbines can be present. The different types of wind turbines can be classified based on manufacturer, sizes, power output, model, and other differences.

Artificial intelligence models can be used to manage these assets. In some cases, each wind turbine may have an artificial intelligence model. In other cases, a single wind turbine may have multiple artificial intelligence models. In yet other illustrative examples, a group of wind turbines may be managers using a single artificial intelligence model. In yet other illustrative examples, multiple artificial intelligence models may be used to manage a group of wind turbines.

As another example, a power plant company may manage various power plants in different locations. These power plants may use inductive draft fans to create negative pressure to draw out undesired gases. These fans are used with other equipment to maintain proper airflow and ventilation. The power plant company may have hundreds of thousands of these types of fans as assets that can be managed.

Generating artificial intelligence models for the assets on a windfarm or multiple windfarms can be a time consuming task. It would be desirable to have an automated process for generating artificial intelligence models for assets. The illustrative embodiments provide a computer implemented method, apparatus, system, and computer program product for creating artificial intelligence models. This process can be used to create artificial intelligence models in a factory process that enables scaling the creation of artificial intelligence models for assets.

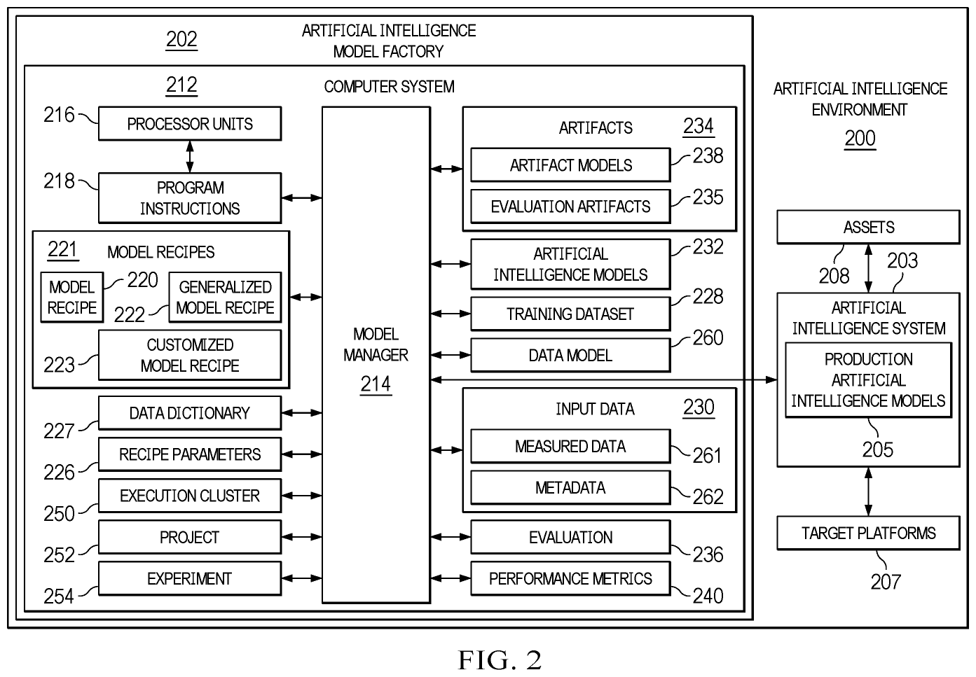

With reference now to FIG. 2, a block diagram of an artificial intelligence environment is depicted in accordance with an illustrative embodiment. In this illustrative example, artificial intelligence environment 200 includes components that can be implemented in hardware such as the hardware shown in computing environment 100 in FIG. 1. Artificial intelligence model factory 202 operates to generate artificial intelligence system 203. Artificial intelligence system 203 comprises a set of production artificial intelligence models 205. As used herein, a “set of” when used with reference to items means one or more items. For example, a set of production artificial intelligence models 205 is one or more production artificial intelligence models 205.

Artificial intelligence system 203 can be comprised of one or more artificial intelligence models that can be of the same type or different types. For example, artificial intelligence system 203 can be comprised of at least one of least one of a single artificial intelligence model intelligence model for a single asset in assets 208, multiple artificial intelligence models for each asset in the assets, a single artificial intelligence model for a group of assets 208 in assets 208, or multiple artificial intelligence models for multiple assets in assets 208.

In this example, the set of production artificial intelligence models 205 are artificial intelligence models in a form that can run on a set of target platforms 207. For example, formatting, adding interfaces, and other changes or additions can be performed to enable the artificial intelligence models to run on the set of target platforms 207. Target platforms 207 can be selected from at least one of a mobile phone, a mobile device, an edge device, a tablet, a server computer, a gateway, a server computer in a cloud computing system, a robot, a vehicle, a computing cluster, or some other suitable type of platform.

Artificial intelligence system 203 can be created for use with assets 208 based on a task for assets 208. Assets 208 can take a number of different forms. For example, assets 208 can be at least one of a wind turbine, a robot, an oil well, a gas well, the composite tape layup machine, a computer numeric control machine, a gearbox, a process, a pump, an induction fan, a chemical vapor deposition machine, or other suitable type of asset.

In this example, artificial intelligence model factory 202 comprises computer system 212 and model manager 214. As depicted, model manager 214 is located in computer system 212. Model manager 214 may be implemented using model manager 190 in FIG. 1.

Model manager 214 can be implemented in software, hardware, firmware, or a combination thereof. When software is used, the operations performed by model manager 214 can be implemented in program instructions configured to run on hardware, such as a processor unit. When firmware is used, the operations performed by model manager 214 can be implemented in program instructions and data and stored in persistent memory to run on a processor unit. When hardware is employed, the hardware can include circuits that operate to perform the operations in model manager 214.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes in the illustrative examples. In other words, program instructions 218 are computer readable program instructions.

As used herein, a processor unit in the number of processor units 216 is a hardware device and is comprised of hardware circuits such as those on an integrated circuit that respond to and process instructions and program code that operate a computer. A processor unit can be implemented using processor set 110 in FIG. 1. When the number of processor units 216 executes program instructions 218 for a process, the number of processor units 216 can be one or more processor units that are in the same computer or in different computers. In other words, the process can be distributed between processor units 216 on the same or different computers in computer system 212.

Further, the number of processor units 216 can be of the same type or different types of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, model manager 214 generates artificial intelligence system 203 using model recipe 220. In this example, model recipe 220 is a model recipe in model recipes 221. Model recipe 220 is a functional component that defines steps to build an artificial intelligence model for artificial intelligence system 203 from input, identifying candidate types of artificial intelligence models for artificial intelligence system 203, and training the candidate artificial intelligence models.

Further, model recipe 220 can also include steps for deploying artificial intelligence system 203. Model recipe 220 can also include steps for monitoring the performance and retraining of artificial intelligence models in artificial intelligence system 203. In other illustrative examples, different recipes can be used for training, deployment, and maintenance.

In one illustrative example, the steps in model recipe 220 can be steps that are interpreted by model manager 214 or by another process or application. In another illustrative example, model recipe 220 can include program code or instructions that are executed to implement the steps in model recipe 220. With this example, model manager 214 can select and execute model recipe 220.

In this depicted example, the steps in model recipe 220 are performed automatically without requiring user intervention to train and create artificial intelligence models for use with assets 208. User input can be received in the form of input data for training and identification of recipe parameters 226 in model recipe 220 that are used to perform the different steps in creating, deploying, and maintaining artificial intelligence system 203. As a result, a user does not need to have special knowledge or experience in creating artificial intelligence models.

Further, the different steps in model recipe 220 can be implemented as tasks performed by program code in model recipe 220. For example, the program code can take the form of a script or multiple scripts.

Model recipes 221 can take a number of different forms. For example, model recipes 221 can be generalized model recipe 222 or customized model recipe 223. For example, when model recipe 220 is generalized model recipe 222, this recipe may be for artificial intelligence models directed towards a particular task without identifying a particular asset class of assets. For example, generalized model recipe 222 can be a recipe for generating artificial intelligence models for tasks such as anomaly detection, a failure prediction, time series failure prediction, a survival analysis, data quality, and health forecasting and other suitable types of tasks.

As another example, model recipe 220 is customized model recipe 223 that can be for a specific type of asset in assets 208. For example, if the asset is a wind turbine, a specific customized model recipe for creating artificial intelligence system 203 for a wind turbine or multiple wind turbines can be selected. As another example, if an asset is an oil well, a specific customized model recipe in model recipes 221 for oil wells can be selected for use in creating artificial intelligence system 203 for use with the oil well or multiple wells.

Customized model recipe 223 can use data dictionary 227 to process and organize input data 230. Data dictionary 227 can be used to generate data model 260. Data model 260 can be specific to different asset entities in assets 208 such as to particular assets or classes of assets within assets 208.

In this example, data dictionary 227 can be used to group and organize input data 230 to form data model 260 such that training of artificial intelligence models 232 can be performed more effectively. This data dictionary can be used instead of a user having to determine what organizations of input data 230 is most effective for training assets 208.

Model manager 214 identifies recipe parameters 226 specified in model recipe 220 selected for use. Recipe parameters 226 can take a number of different forms. For example, recipe parameters 226 can be selected from at least one of an application specific parameter, a learning parameter, or training level.

In this example, an application specific parameter can be an asset ID, a timestamp, an input feature, an output target, a prediction window size which denotes the forecast horizon, or some other suitable parameter. The learning parameter can be, for example, a single task or a multitask.

In these examples a single task means that a different artificial intelligence model is trained for each asset. With a multitask, an artificial intelligence model can be trained on multiple assets.

A training level can be a level at which an artificial intelligence model is trained. For example, a training level can be basic, advanced, or comprehensive. The basic level uses model training such as statistical forecasting methods. These statistical forecasting methods can include autoregressive integrated moving average (ARIMA) which performs a time series analysis to predict future values based on historical patterns and data. This basic training level focuses on fundamental concepts and limited data complexity. In this type of learning, the model learns basic patterns and makes relatively simple predictions.

In this example, the advanced level performs additional training with the artificial intelligence models. With this level of training, increased data complexity algorithms and training methods are used. At a comprehensive level, a wide range of techniques and methodologies are used for training the artificial intelligence model, and the comprehensive level can include using deep learning to train artificial intelligence models. The particular level selected for the training level parameter can depend on the complexity of the task to be handled by the artificial intelligence model.

Further, recipe parameters 226 can also be used in customized model recipe 223 to further organize input data 230 in addition to using data dictionary 227. For example, application specific parameters can be used to indicate what parameters may be important for use as labels in creating training dataset 228. As another example, a learning parameter can indicate that the training should be performed as multitask training in which an artificial intelligence model strata multiple assets such as assets in the same class.

This type of indication can be used to group input data 230 based on classifications of assets 208. For example, input data can be grouped for assets 208 based on model type, maintenance frequency, location, usage time, when assets are used, or based on other types of groupings. This type of information can be input as recipe parameters 226 and in particular as application specific parameters.

Model manager 214 creates training dataset 228 using model recipe 220 and input data 230. Training dataset 228 is data that is organized and formatted for use in training the set of artificial intelligence models 232. Input data 230 comprises measured data 261 for assets 208.

In these examples, measured data 261 is data about measurable properties for the assets. Measured data 261 can be at least one of sensor data, time series data, or other data relating to assets 208. Measured data 261 can be processed to drive features or other information that can be used to train and artificial intelligence model. Further, input data 230 can also include metadata 262 describing assets 208 and the measured data 261.

When model recipe 220 is customized model recipe 223, training dataset 228 includes data model 260. Data model 260 contains data for training and metadata describing assets 208 and can be organized for training the model for specific types of assets 208. This organization is described by customized model recipe 223.

Model manager 214 trains a set of artificial intelligence models 232 using training dataset 228, recipe parameters 226, and model recipe 220 to create artifacts 234. In one illustrative example, in training the set of artificial intelligence models 232, model manager 214 identifies resources for training the set of artificial intelligence models 232 using model recipe 220. In this example, factors such as the different steps in training, the amount of input data 230, the preprocessing and cleaning of input data 230, and other tasks performed in training can be used to determine the amount of resources needed.

In this example, model manager 214 creates execution cluster 250 based on the resources identified. Model manager 214 trains a set of artificial intelligence models 232 in execution cluster 250 using training dataset 228 and model recipe 220.

In this example, model recipe 220 can identify the different steps to be performed in training based on recipe parameters 226. For example, a learning parameter in recipe parameters 226 can be used to determine what types of artificial intelligence models are to be trained and how many artificial intelligence models should be trained. Further, the training level in recipe parameters 226 can indicate how much training and the type of training that should be used. For example, depending on the level training, supervising or unsupervised may be specified in recipe parameters 226.

In this illustrative example, execution cluster 250 is group of containers used for performing and managing tasks in performing training and other steps in performing experiment 254. The result of experiment 254 is an output of artifacts 234. Artifacts 234 can include artifact models 238 and evaluation artifacts 235. In this example, artifact models 238 are the artificial intelligence models resulting from training artificial intelligence models 232.

Evaluation artifacts 235 can be information about the performance of artifact models 238. In this example, evaluation artifacts 235 can be various metrics monitored and collected during training of artificial intelligence models 232. These evaluation artifacts can be performance metrics selected from at least one of accuracy, precision, recall, error rate, or other types of performance for the set of artificial intelligence models 232.

In these examples, execution cluster 250 is scalable to provide parallel processing for tasks when appropriate as well as efficient use of processing resources. This clustering of containers in execution cluster 250 can increase the scalability for training artificial intelligence models 232 to take into account recipe parameters 226 for model recipe 220. In one example, containers can be implemented in a Kubernetes environment or platform.

In this illustrative example, the training performed by model manager 214 can include creating project 252 for creating the set of artifact models 238. In this example, project 252 comprises multiple steps. Project 252 is a request or ticket for training artificial intelligence models 232. The steps for project 252 are identified using model recipe 220 and other information such as recipe parameters 226 and input data 230.

Model manager 214 runs experiment 254 for project 252 that creates artifact models 238. In this example, the experiment is run using execution cluster 250. In this example, experiment 254 is an application or process that performs the different tasks for training artificial intelligence models 232 identified in project 252.

Model manager 214 evaluates artifacts 234 resulting from training the set of artificial intelligence models 232 to form evaluation 236. For example, model manager 214 can use evaluation artifacts 235 in artifacts 234 to determine which artifact models have better performance. Model manager 214 selects a set of artifact models 238 in artifacts 234 for artificial intelligence system 203 using evaluation 236. For example, model manager 214 can select the set of artifact models 238 from artifact models having the best scores for one or more performance metrics. For example, model manager 214 can select the top model artifact, the top five model artifacts, or some other number of model artifacts based on performance metrics in evaluation 236.

In this model manager 214 can also use model recipe 220 to perform additional actions in addition to creating artificial intelligence system 203. Model manager 214 can deploy artificial intelligence system 203 to a set of target platforms 207 using model recipe 220.

For example, model manager can deploy artificial intelligence system 203 by identifying the set of target platforms 207 for artificial intelligence system 203. The target platforms can be deployed from user input selecting target platforms 207 and providing information about target platforms 207.

Model manager 214 creates a set of production artificial intelligence models 205 to form artificial intelligence system 203 to run on set of target platforms 207 using model recipe 220 and the set of artifact models 238 in artifacts 234. In creating the set of production artificial intelligence models 205, model manager 214 can make changes or adjustments to the set of artifact models 238 to form the set of production artificial intelligence models 205.

For example, an artifact model may be modified or formatted to be compatible with a target platform. In this example, if an artifact model is to be deployed on a target platform such as a mobile device, the artifact model may require conversion to a format compatible with mobile frameworks such as tensor flow or Core ML. As yet another example, if an artifact model is to be deployed on a server computer in a cloud environment, the artifact model may be formatted to work within the specific infrastructure platform being used by the server computer.

Further, in creating the set of production artificial intelligence models 205, model manager 214 can also create code or a package for loading the artificial intelligence model to the platform as well as to handle input data and process model predictions generated by the production artificial intelligence model and inform typically used by the target platform. Model manager 214 deploys artificial intelligence system 203 comprising the set of production artificial intelligence models 205 to the set of target platforms 207 using model recipe 220.

Further in this illustrative example, model manager 214 can perform maintenance for artificial intelligence system 203 that has been deployed to target platforms 207. For example, model manager 214 monitors a number of performance metrics 240 based on evaluation artifacts 235 in artifacts 234. In one example·performance metrics 240 can be selected from at least one or more of accuracy, precision, recall, error rate, or other types of performance for the set of production artificial intelligence models 205 based these metrics as identified in evaluation artifacts 235.

In this example, model manager 214 can retrain one or more of production artificial intelligence models 205 in artificial intelligence system 203 based on the number of performance metrics 240. In this example, the retraining of a production artificial intelligence model can include using sensor data from performing different tasks with respect to assets 208 as feedback. This sensor data can be received in a feedback loop for use in performing additional training. In other cases, the training may be continuous as a production artificial intelligence model operates to perform tasks for assets 208. In this example, the deployment can be performed using agents that are generated and deployed as part of artificial intelligence system 203 to target platforms 207.

Model manager 214 can perform retraining of one or more production artificial intelligence models 205 and artificial intelligence system 203 based on the number of performance metrics 240. For example, if an error level for an error in performance metrics 240 increases beyond the threshold, retraining can be performed. In another example, if an accuracy level for accuracy metric decreases below a threshold, retraining can also be performed.

In one illustrative example, one or more solutions are present that overcome a problem with creating large numbers of artificial intelligence models to manage large numbers of assets. For example, hundreds of thousands of artificial intelligence models can be needed to manage, monitor, or for other uses, with thousands or hundreds of thousands of assets. As a result, one or more illustrative examples provide an automated system for creating artificial intelligence models that are scalable to large numbers of assets. Further, in the different illustrative examples, the process for creating artificial intelligence models is automated to avoid the need for user intervention in managing the creation of artificial intelligence models. In the illustrative example, a recipe is selected for a particular task for assets. With the selection of the recipe, inputs such as input data and recipe parameters for the selected recipe are received and used to create and deploy artificial intelligence to target platforms for use with the assets. Further, the recipe can also be used to perform maintenance and retraining of artificial intelligence models as needed during use of those artificial intelligence models.

Computer system 212 can be configured to perform at least one of the steps, operations, or actions described in the different illustrative examples using software, hardware, firmware, or a combination thereof. As a result, computer system 212 operates as a special purpose computer system in which model manager 214 in computer system 212 enables generating and artificial intelligence system comprising artificial intelligence models. In particular, model manager 214 transforms computer system 212 into a special purpose computer system as compared to currently available general computer systems that do not have model manager 214.

In the illustrative example, the use of model manager 214 in computer system 212 integrates processes into a practical application for generating artificial intelligence system that uses model recipe to automatically perform steps in generating one or more artificial intelligence models for use with assets. In the different illustrative examples, the model recipe is a component that defines and implements steps for generating the artificial intelligence system for use with assets. Model manager 214 can automatically perform steps based on inputs such as input data for the assets and recipe parameters. The steps in the recipe can be implemented in program code, scripts, or other forms that can be executed by processor units in a computer system.

Thus, the illustrative embodiments provide a computer implemented method, apparatus, computer system, and computer program product for generating and artificial intelligence system. In the different illustrative examples, the process is driven using a model recipe. The model recipe can be a general recipe based on a task or can be specific to a particular asset or class of assets. With the use of the recipe to automate artificial intelligence model generation, increased scalability is present especially when large number of assets are present. The illustrative examples can be especially useful when hundreds of thousands or more assets with a similar class are present.

The illustration of artificial intelligence environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

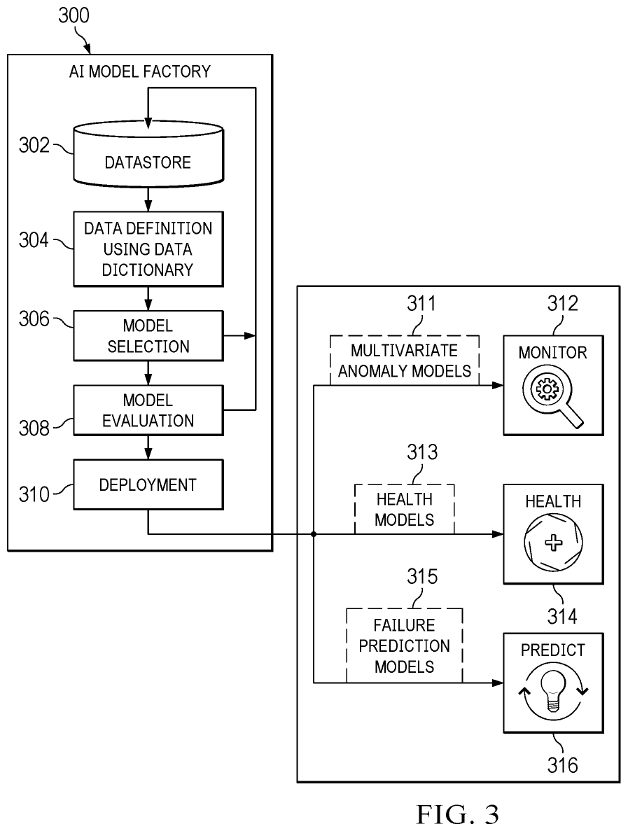

With reference next to FIG. 3, an illustration of an artificial intelligence model factory is depicted in accordance with an illustrative embodiment. In this illustrative example artificial intelligence (AI) model factory 300 is an example of an implementation for artificial intelligence model factory 202 shown in block form in FIG. 2.

As depicted, AI model factory 300 creates a data model using a data dictionary in block 304. The data model can be data model 260 in FIG. 2. In this example, this data model is created using input data stored in datastore 302. In this example, the input data can be measurement data and metadata for a training dataset. The measurement data can be, for example, sensor data or other data measured or otherwise obtained with respect to the assets.

In this example, the data dictionary can be used to identify how data and metadata, such as asset organization and data organization, are used to create the data model. For example, input data used in block 304 can be sensor data from 3,000 wind turbines. Input data such as sensor data and metadata about the assets can be processed using a data dictionary to form a data model in block 304. The data model comprises data and metadata for multiple assets. For example, the data can be for hundreds or thousands of assets.

This data model can be used to identify a grouping for input data in block 304. This grouping can be an example of data for the assets based on model identifiers, asset classes, or other types of metadata for the assets. For example, asset classes for wind farms can include asset classes such as windfarm, wind turbine, generator, and gearbox. The organization of these asset classes can be related to each other in a hierarchy. The data organization can indicate how data should be organized in data structures.

In this example, AI model factory 300 uses a recipe to perform model selection 306. Further, application specific parameters in recipe parameters in the data definition created in block 304 can also be used to select types of artificial intelligence models that should be trained. For example, the application specific parameters can determine whether each asset should have an artificial intelligence model, whether an asset should have multiple artificial intelligence models, or whether multiple assets are grouped into cohorts as one or more artificial intelligence models. Further, based on information about the assets in the task, different types of artificial intelligence models can be selected for use in training.

In this example, model evaluation 308 includes training the selected artificial intelligence models. In this example, model evaluation 308 can be performed using scalable model pipelines to train the artificial intelligence models for the different assets. Model evaluation 308 also evaluates the trained artificial intelligence models to determine which ones of the trained artificial intelligence model are suitable for use for the assets of interest. The results of training can be used to update input datastore in datastore 302 for further processing and use in training.

Additionally, these results can also be used to provide information to update the data definition made using the data dictionary in block 304. This update may result in the selection of different types and different numbers of artificial models in model selection 306. The results of model evaluation 308 can take the form of a report that is stored in datastore 302.

The process then performs deployment 310 using the models identified as being most suitable for particular assets. In this example, deployment 310 can involve deploying artificial intelligence models to target platforms in different environments. In this example, the environments include monitor environment 312, health environment 314, and predict environment 316.

As depicted, multivariate anomaly models 311 are deployed into monitor environment 312. These models are used to manage and detect anomalies that may occur for assets in monitor environment 312. As another example, health models 313 are deployed to health environment 314. These artificial intelligence models are used in health environment 314 to manage asset health. As yet another example, failure prediction models 315 are deployed to predict environment 316. These models are used to predict failures of assets in predict environment 316.

Illustration of these three environments are only meant as examples and not to limit the environments in which other models can be deployed. In some illustrative examples, only monitor environment 312 may be present. In other illustrative examples, additional environments can include regression analysis environment that analyzes data generated by assets using regression-based artificial intelligence models.

In this example, the different models generated in deployed by deployment 310 are generated automatically using recipes. Further, In this example, each of the environments have an artificial intelligence model generated using a recipe that is directed to that particular type of environment such as a model-based generalized recipe based on the tasks such as monitoring for anomalies. In other examples, the recipe can be a model dictionary based, customized recipe, that is directed towards training artificial intelligence models based on the particular type of asset. For example, a particular recipe can be used to generate artificial intelligence models to monitor for anomalies in wind turbines in monitor environment 312. A different recipe is used to generate artificial intelligence models to monitor for anomalies in valves.

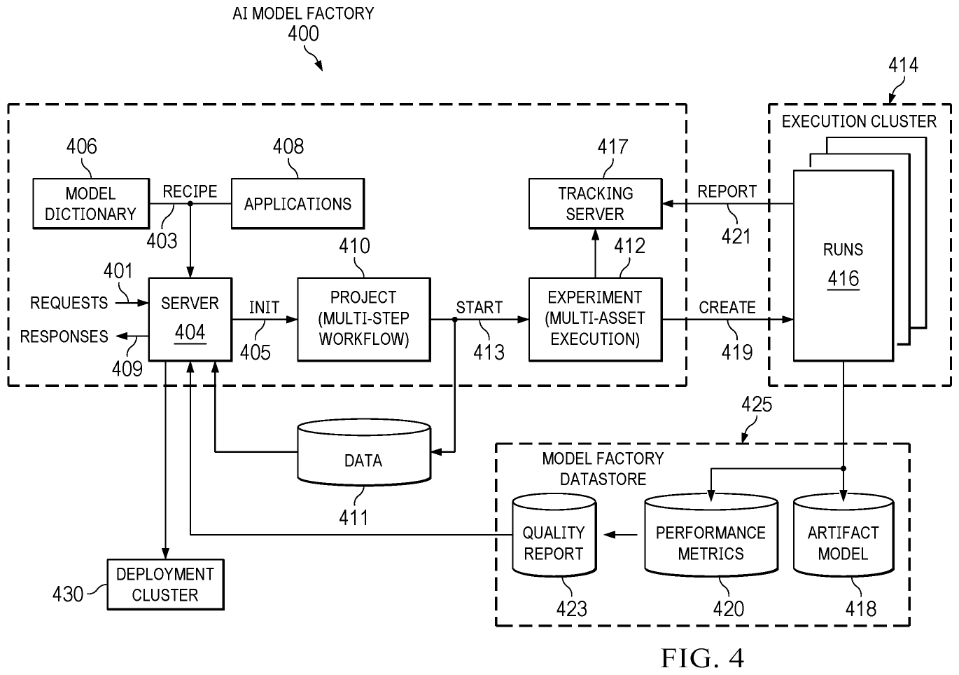

With reference next to FIG. 4, an illustration of an artificial intelligence model factory is depicted in accordance with an illustrative embodiment. In this example, artificial intelligence (AI) model factory 400 is an example of an implementation for artificial intelligence model factory 202 shown in block form in FIG. 2.

In this illustrative example, requests 401 can be received by server 404 to create artificial intelligence models for deployment. In this illustrative example, the request can include a selection of a recipe or recipes for use in generating artificial intelligence models. In this example, recipe 403 is selected from recipes stored in model dictionary 406 in response to a request in requests 401. The selection of recipe 403 can be in the request. This recipe can be selected based on a number of different factors such as an asset class of interest and can be selected from generalized recipes or a specialized recipes.

In this example, different recipes can be present. For example, generalized model recipes and customized model recipes can be present in model dictionary 406 for use in generating artificial intelligence models. Additionally, model dictionary 406 can also include recipes for use in deployment and maintenance of artificial intelligence models.

In some illustrative examples, a recipe may include two or more functions such as model generation, model deployment, and model maintenance. Thus, the recipes in model dictionary 406 can define how to build an artificial intelligence model starting from data collection to data preprocessing to model discovery process. In this example, the model discovery process is used to identify types of models training to create artificial intelligence models. The recipes can also define how to deploy the artificial intelligence model into the target deployment infrastructure. Further, the recipes can also define how to monitor the performance of the artificial intelligence model and retrain the model as needed based on the monitoring.

In this example, server 404 can generate an instance of an application and applications 408 using recipe 403 selected for use and recipe parameters received in the request. In this example, the recipe parameters can include, for example, an application specific parameter, a learning parameter, and training level. In this example, an application is a program that handles requests 401 received by server 404.

Recipe 403 and the recipe parameters are submitted to server 404 to create project 410. In this example, project 410 is a multistep workflow. In other words, project 410 includes various steps such as artificial intelligence model selection, trainings, data normalization, data cleaning, dataset creation, labeling, training selection, and other steps.

Additionally, data 411 can also be submitted to server 404 to create project 410. Data 411 is input data for the assets and can be identified from requests 401 received by server 404. In this example, data 411 comprises training data and metadata. The training data and metadata can be organized into a data model for use in training machine learning models.

In this example, server 404 can generate an instance of an application in applications 408 as project 410 using an initialization function such as init 405. In this example, project 410 is similar to a request or ticket for performing the steps in recipe 403. Server 404 creates bookkeeping information representing project 410 to indicate that a request has been submitted. In this example, server 404 creates an entry or log. Server 404 returns an identifier back to the user in a response in responses 409.

This identifier can be used to track the status of the request. For example, a user can use the identifier to receive progress information, failure, log information, or other information.

When start 413 occurs for project 410, experiment 412 executes the steps identified in project 410. In this example, experiment 412 performs multi-asset execution. In other words, steps are performed to train artificial intelligence models for multiple assets.

In this example, experiment 412 estimates the workload needed to perform the different tasks needed to create the artificial intelligence models. These tasks include, for example, cleaning data, normalizing data, organizing the data and other tasks to create a training data set. Further, the task also tasks for training and testing the artificial intelligence models.

In this example, the workload can be a function of at least one of what a user wants to do, where the data is located, how many assets are present, how many models are to be generated, or other factors. This workload can be used to identify resources that are needed such as processor time, memory, and other resources.

Once experiment 412 estimates the workload, experiment 412 makes an update to project 410. In this manner, the user can make query to obtain information about the status of the training.

In this example, experiment 412 initiates create 419 as a request to create execution cluster 414. This request can include the location of where the cluster should be. For example, the location of the cluster relative to the location of data 411 can reduce the amount of resources and time needed to train artificial intelligence models.

In this example, experiment 412 creates multiple tasks that are executed as runs 416 in execution cluster 414. Execution clusters are responsible for executing the runs. In this example, each run in runs 416 is a containerized application and dedicated to executing a single task at a time. Further, in this example, runs 416 in execution cluster 414 request data and instruction along with access to tracking server 417. Updates can be sent in report 421 to tracking server 417 to continuously update the progress of runs 416.

At the end of task execution, depending on the nature of the task, the output can be performance metrics 420 for the artificial intelligence model. In this example, performance metrics 420 are stored in model factory datastore 425. The training artificial intelligence model is stored as artifact model 418 in model factory datastore 425.

In this example, performance metrics 420 can be used to generate quality report 423 in model factory datastore 425. Quality report 423 can be reviewed and analyzed by various users or experts. Quality report 423 can be used to make adjustments to the speed of the changes. Further, quality report 423 can also be used to update data 411 or update the manner in which data 411 is normalized, cleaned, or otherwise processed for use in training.

In this example, project 410 can also be initialized for deploying artifact model 418. This project can be initialized as part of recipe 403 or an entirely new recipe for deploying artificial intelligence models can be selected. Artifact model 418 can be deployed to different target platforms in deployment cluster 430. With the deployment, execution cluster 414 can use runs 416 to perform tasks to deploy artifact model 418. For example, tasks such as an adjustment to artifact model 418 to convert artifact model 418 into a model type or format that can be used in a particular target platform in deployment cluster 430. In a similar fashion, a recipe can be selected to perform maintenance on a production artificial intelligence model created from artifact model 418.

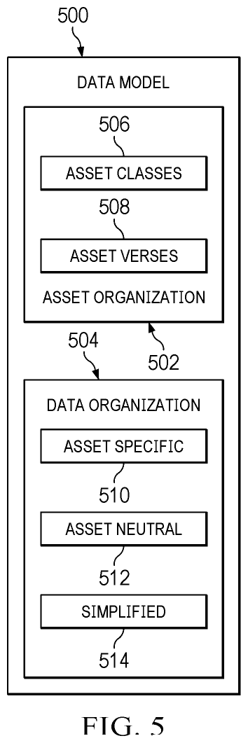

With reference next to FIG. 5, an illustration of a data model is depicted in accordance with an illustrative embodiment. Data model 500 is an example of training dataset 228 in FIG. 2. This data model enables context aware training of artificial intelligence models. The organization of the contents in data model 500 are specified in a recipe.

As depicted, data model 500 is an example of a data dictionary used in block 304 in AI model factory 300 in FIG. 3. As depicted, data model 500 can provide definitions of how metadata should be organized. For example, data model 500 can specify asset organization 502 and data organization 504.

Asset organization define the manner in which metadata about how assets are organized. For example, asset organization 502 includes asset classes 506 and asset verses 508. This information derived can be used to organize metadata about assets. Asset classes are the types of assets that may be present. For example, asset classes for industrial assets such as those used in wind generation can include wind farm, wind turbine, generator, and gearbox. Asset verses 508 can be a level or higher key definition for the different asset classes.

In this example, data organization 504 identifies how data should be organized. In this example, the data can be sensor data. The organization can be based on a process, a sensor, measurements, asset type, or other elements. In this example, data organization 504 can take a number of different forms. For example, data organization 504 can be asset specific 510, asset neutral 512, and simplified 514.

In this example, asset specific 510 is used to create training datasets in which the data is organized for the particular asset. This involves collecting and labeling data that directly relates to the assets. This type of data organization can result in a dataset that is highly relevant and specific to the desired outcomes with respect to the asset.

With asset neutral 512, the data is organized in a manner that is more generalized to a wider range of assets. For example, with this type of data organization, the data can be organized based on types of form groupings of assets. This type of data organization can enable an artificial intelligence model to learn broader patterns and be more adaptable to different inputs.

As another example of data organization 504, simplified 514 reduces the complexity in size of training datasets for the artificial intelligence models. This type of dataset typically involves preprocessing and condensing data. This type of processing can include at least one of dimensionality reduction, feature extraction, or summarization. This type of organization data can reduce the complexity and maintain the meaning of the data. As result, training time can be reduced using simplified 514 as a type of data organization.

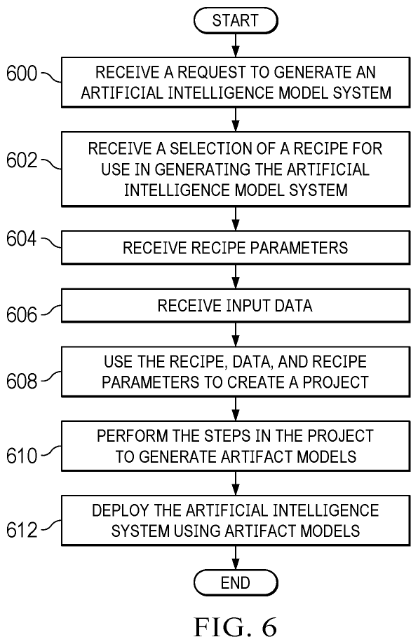

With reference next to FIG. 6, a flowchart of a process for generating an artificial intelligence system is depicted in accordance with an illustrative embodiment. The process in FIG. 6 can be implemented in hardware, software, or both. When implemented in software, the process can take the form of program instructions that are run by one of more processor units located in one or more hardware devices in one or more computer systems. As another example, this process can be implemented in artificial intelligence model factory 400 in FIG. 4.

The process begins by receiving a request to generate an artificial intelligence model system (step 600). The process receives a selection of a recipe for use in generating the artificial intelligence model system (step 602). In step 602, the user may select an asset class of interest for a particular type of asset. This type of recipe can be a model dictionary based customize recipe. If a recipe is available for the particular type of asset, then that recipe can be selected. In other examples, a more generic recipe can be selected. This more generic recipe is a generalized model recipe.

The process receives recipe parameters (step 604). In step 604, the recipe parameters can be application specific parameters, learning parameters, or training levels. The process receives input data (step 606). In step 606, the input data includes measured data and metadata for the assets.

The process then uses the recipe, data, and recipe parameters to create a project (step 608). In step 608, the project identifies multiple steps in a workflow that are to be performed based on the recipe, the data, and the recipe parameters. The recipe identifies what steps should be performed to train machine learning models. The recipe can also identify the steps needed to select which training artificial intelligence model should be used after training is completed. In other words, the project is an implementation of the recipe based on the data and recipe parameters.

The process then performs the steps in the project to generate artifact models (step 610). The process deploys the artificial intelligence system using artifact models (step 612). The process terminates thereafter.

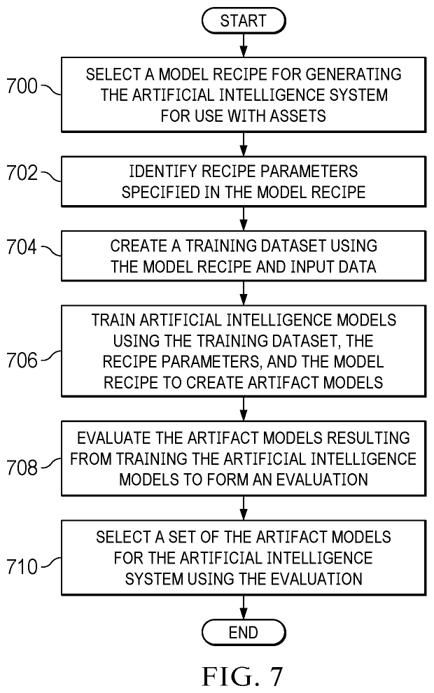

Turning next to FIG. 7, a flowchart of a process for generating an artificial intelligence system is depicted in accordance with an illustrative embodiment. The process in FIG. 7 can be implemented in hardware, software, or both. When implemented in software, the process can take the form of program instructions that are run by one of more processor units located in one or more hardware devices in one or more computer systems. For example, the process can be implemented in model manager 214 in computer system 212 in FIG. 2.

The process begins by selecting a model recipe for generating the artificial intelligence system for use with assets (step 700). The process identifies recipe parameters specified in the model recipe (step 702).

The process creates a training dataset using the model recipe and input data (step 704). The process trains artificial intelligence models using the training dataset, the recipe parameters, and the model recipe to create artifact models (step 706).

The process evaluates the artifact models resulting from training the artificial intelligence models to form an evaluation (step 708). The process selects a set of the artifact models for the artificial intelligence system using the evaluation (step 710). The process terminates thereafter.

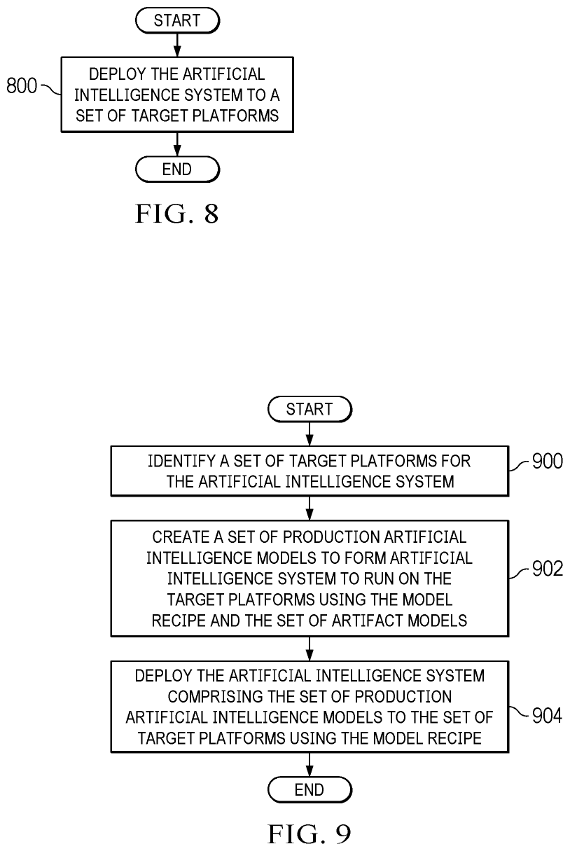

Turning next to FIG. 8, a flowchart of a process for deploying an artificial intelligence system is depicted in accordance with an illustrative embodiment. The process in this figure is an example of an additional step that can be formed with the steps in FIG. 7.

The process deploys the artificial intelligence system to a set of target platforms (step 800). The process terminates thereafter.

With reference to FIG. 9, a flowchart of a process for deploying an artificial intelligence system is depicted in accordance with an illustrative embodiment. The process in this figure is an example of an implementation for step 800 in FIG. 8.

The process identifies a set of target platforms for the artificial intelligence system (step 900). The process creates a set of production artificial intelligence models to form artificial intelligence system to run on the target platforms using the model recipe and the set of artifact models (step 902).

The process deploys the artificial intelligence system comprising the set of production artificial intelligence models to the set of target platforms using the model recipe (step 904). The process terminates thereafter. In some illustrative examples, the deployment can be performed using a different recipe from the recipe used to create the artificial intelligence system.

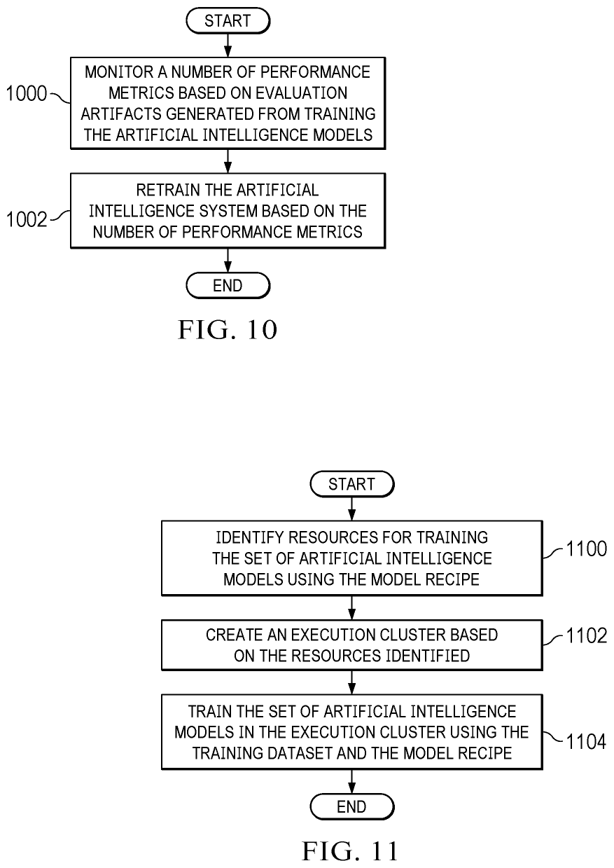

In FIG. 10, a flowchart of a process for monitoring and artificial intelligence system after deployment is depicted in accordance with an illustrative embodiment. The process in this figure is an example of additional steps that can be performed with the process in FIG. 8.

The process monitors a number of performance metrics based on evaluation artifacts generated from training the artificial intelligence models (step 1000). The process retrains the artificial intelligence system based on the number of performance metrics (step 1002). The process terminates thereafter. In step 1002, the retraining can be performed for one or more production artificial intelligence models in the artificial intelligence system. In other words, retraining may be performed for a portion of the artificial intelligence system depending on the performance metrics.

With reference now to FIG. 11, a flowchart of a process for training a set of artificial intelligence models is depicted in accordance with an illustrative embodiment. The process in this figure is an example of an implementation for step 706 in FIG. 7.

The process identifies resources for training the set of artificial intelligence models using the model recipe (step 1100). The process creates an execution cluster based on the resources identified (step 1102).

The process trains the set of artificial intelligence models in the execution cluster using the training dataset and the model recipe (step 1104). The process terminates thereafter. In some illustrative examples, the training dataset can be or include a data model such as data model 260 in FIG. 2 or data model 500 in FIG. 5. This data model can be used with recipes that are for specific assets or classes of assets.

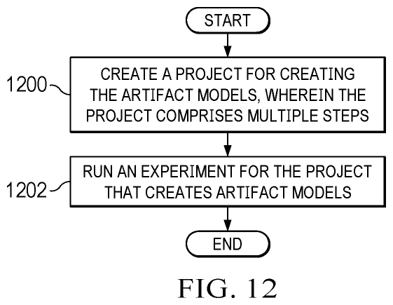

Turning to FIG. 12, a flowchart of a process for training a set of artificial intelligence models is depicted in accordance with an illustrative embodiment. The process in this figure is an example of an implementation for step 706 in FIG. 7.

The process creates a project for creating the artifact models, wherein the project comprises multiple steps (step 1200). The process runs an experiment for the project that creates artifact models (step 1202). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

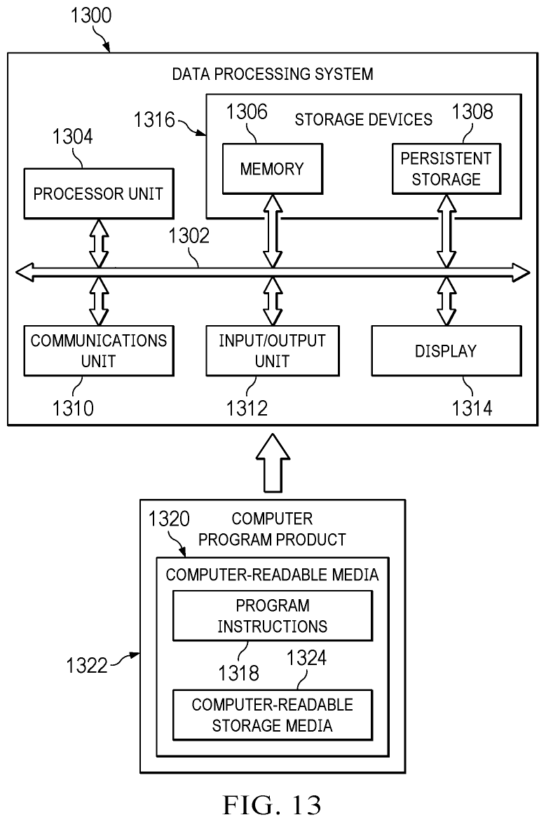

Turning now to FIG. 13, a block diagram of a data processing system is depicted in accordance with an illustrative embodiment. Data processing system 1300 can be used to implement computers and computing devices in computing environment 100 in FIG. 1. Data processing system 1300 can also be used to implement computer system 212 in FIG. 2. In this illustrative example, data processing system 1300 includes communications framework 1302, which provides communications between processor unit 1304, memory 1306, persistent storage 1308, communications unit 1310, input/output (I/O) unit 1312, and display 1314. In this example, communications framework 1302 takes the form of a bus system.

Processor unit 1304 serves to execute instructions for software that can be loaded into memory 1306. Processor unit 1304 includes one or more processors. For example, processor unit 1304 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1304 can be implemented using one or more heterogeneous processor systems in which a main processor is present with secondary processors on a single chip. As another illustrative example, processor unit 1304 can be a symmetric multi-processor system containing multiple processors of the same type on a single chip.

Memory 1306 and persistent storage 1308 are examples of storage devices 1316. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1316 may also be referred to as computer readable storage devices in these illustrative examples. Memory 1306, in these examples, can be, for example, a random-access memory or any other suitable volatile or non-volatile storage device. Persistent storage 1308 may take various forms, depending on the particular implementation.

For example, persistent storage 1308 may contain one or more components or devices. For example, persistent storage 1308 can be a hard drive, a solid-state drive (SSD), a flash memory, a rewritable optical disk, a rewritable magnetic tape, or some combination of the above. The media used by persistent storage 1308 also can be removable. For example, a removable hard drive can be used for persistent storage 1308.

Communications unit 1310, in these illustrative examples, provides for communications with other data processing systems or devices. In these illustrative examples, communications unit 1310 is a network interface card.

Input/output unit 1312 allows for input and output of data with other devices that can be connected to data processing system 1300. For example, input/output unit 1312 may provide a connection for user input through at least one of a keyboard, a mouse, or some other suitable input device. Further, input/output unit 1312 may send output to a printer. Display 1314 provides a mechanism to display information to a user.

Instructions for at least one of the operating system, applications, or programs can be located in storage devices 1316, which are in communication with processor unit 1304 through communications framework 1302. The processes of the different embodiments can be performed by processor unit 1304 using computer-implemented instructions, which may be located in a memory, such as memory 1306.

These instructions are referred to as program instructions, computer usable program instructions, or computer readable program instructions that can be read and executed by a processor in processor unit 1304. The program instructions in the different embodiments can be embodied on different physical or computer readable storage media, such as memory 1306 or persistent storage 1308.

Program instructions 1318 are located in a functional form on computer readable media 1320 that is selectively removable and can be loaded onto or transferred to data processing system 1300 for execution by processor unit 1304. Program instructions 1318 and computer readable media 1320 form computer program product 1322 in these illustrative examples. In the illustrative example, computer readable media 1320 is computer readable storage media 1324.

Computer readable storage media 1324 is a physical or tangible storage device used to store program instructions 1318 rather than a medium that propagates or transmits program instructions 1318. Computer readable storage media 1324, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1318 can be transferred to data processing system 1300 using a computer readable signal media. The computer readable signal media are signals and can be, for example, a propagated data signal containing program instructions 1318. For example, the computer readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer readable media 1320” can be singular or plural. For example, program instructions 1318 can be located in computer readable media 1320 in the form of a single storage device or system. In another example, program instructions 1318 can be located in computer readable media 1320 that is distributed in multiple data processing systems. In other words, some instructions in program instructions 1318 can be located in one data processing system while other instructions in program instructions 1318 can be located in one data processing system. For example, a portion of program instructions 1318 can be located in computer readable media 1320 in a server computer while another portion of program instructions 1318 can be located in computer readable media 1320 located in a set of client computers.

The different components illustrated for data processing system 1300 are not meant to provide architectural limitations to the manner in which different embodiments can be implemented. In some illustrative examples, one or more of the components may be incorporated in or otherwise form a portion of, another component. For example, memory 1306, or portions thereof, may be incorporated in processor unit 1304 in some illustrative examples. The different illustrative embodiments can be implemented in a data processing system including components in addition to or in place of those illustrated for data processing system 1300. Other components shown in FIG. 13 can be varied from the illustrative examples shown. The different embodiments can be implemented using any hardware device or system capable of running program instructions 1318.

Thus, illustrative embodiments provide a computer implemented method, computer system, and computer program product for generating an artificial intelligence system. A computer implemented method generates an artificial intelligence system. A number of processor unit selects a model recipe for generating the artificial intelligence system for use with assets. The number of processor units identifies recipe parameters specified in the model recipe. The number of processor units creates a training dataset using the model recipe and input data. The number of processor units trains a set of artificial intelligence models using the training dataset, the recipe parameters, and the model recipe to create artifact models. The number of processor units evaluates the artifact models resulting from training the set of artificial intelligence models to form an evaluation. The number of processor units selects a set of the artifact models in the artifacts for the artificial intelligence system using the evaluation.

In the illustrative examples, the generation of artificial intelligence models for the artificial intelligence system is performed automatically based on a model recipe selected for the assets of interest. In the illustrative examples, model recipe can be general for a specific task. In other examples, the model recipe can be specific to a particular asset or class of assets.

Each model recipe defines how to build an artificial intelligence model for the artificial intelligence system. This definition includes defining steps from data collection to preprocessing to model discovery as well as training the artificial intelligence models for the artificial intelligence system. Further, a recipe can also include steps for deploying in the artificial intelligence model to a target platform. Further, the recipe can also include steps for monitoring the performance of the artificial intelligence system and retraining is needed.

In the illustrative examples, models recipes are used automatically perform tasks to at least one of generating artificial intelligence models, deploy artificial intelligence models, or maintain artificial intelligence models in an artificial intelligence system. In this example, a model recipe can be used by the model manager in the illustrative examples to perform computer implemented steps without needing user intervention. In these examples, a user can select a model recipe and provide input about the assets from which the artificial intelligence system is to be generated. Based on the user input, model manager can automatically initiate steps to generate the artificial intelligence system.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for generating an artificial intelligence system, the computer implemented method comprising:
selecting, by a number of processor units, a model recipe for generating the artificial intelligence system for use with assets;
identifying, by the number of processor units, recipe parameters specified in the model recipe;
creating, by the number of processor units, a training dataset using the model recipe and input data;
training, by the number of processor units, artificial intelligence models using the training dataset, the recipe parameters, and the model recipe to create artifact models;
evaluating, by the number of processor units, artifact models resulting from training the artificial intelligence models to form an evaluation; and
selecting, by the number of processor units, a set of the artifact models for the artificial intelligence system using the evaluation.

2. The computer implemented method of claim 1 further comprising:
deploying, by the number of processor units, the artificial intelligence system to a set of target platforms.

3. The computer implemented method of claim 2, wherein deploying, by the number of processor units, the artificial intelligence system comprises:
identifying, by the number of processor units, a set of target platforms for the artificial intelligence system;
creating, by the number of processor units, create a set of production artificial intelligence models to form artificial intelligence system to run on the target platforms using the model recipe and the set of artifact models; and
deploying, by the number of processor units, the artificial intelligence system comprising the set of production artificial intelligence models to the set of target platforms using the model recipe.

4. The computer implemented method of claim 2 further comprising:
monitoring, by the number of processor units, a number of performance metrics based on evaluation artifacts generated from training the artificial intelligence models; and
retraining, by the number of processor units, the artificial intelligence system based on the number of performance metrics.

5. The computer implemented method of claim 1, wherein training, by the number of processor units, the artificial intelligence models comprises:
identifying, by the number of processor units, resources for training the artificial intelligence models using the model recipe;
creating, by the number of processor units, an execution cluster based on the resources identified; and
training, by the number of processor units, the artificial intelligence models in the execution cluster using the training dataset and the model recipe.

6. The computer implemented method of claim 1, wherein training, by the number of processor units, the artificial intelligence models comprises:
creating, by the number of processor units, a project for creating the artifact models, wherein the project comprises multiple steps; and
running, by the number of processor units, an experiment for the project that creates artifact models.

7. The computer implemented method of claim 5, wherein the model recipe is selected from a group comprising a generalized model recipe and customized model recipe.

8. The computer implemented method of claim 1, wherein the recipe parameters are selected from at least one of an application specific parameter, a learning parameter, and training level.

9. The computer implemented method of claim 1, wherein the artificial intelligence system comprises at least one of a single artificial intelligence model intelligence model for a single asset in the assets, multiple artificial intelligence models for each asset in the assets, a single artificial intelligence model for a group of assets in the assets, or multiple artificial intelligence models for multiple assets in the assets.

10. A computer system for generating an artificial intelligence system, comprising:
one or more processors units;
one or more computer readable storage devices; and
computer program instructions, the computer program instructions being stored on the one or more computer readable storage devices for execution by the one or more processor units to perform one or more operations to:
select a model recipe for generating an artificial intelligence system for use with assets;
identify recipe parameters specified in the model recipe;
create a training dataset using the model recipe and input data;
train artificial intelligence models using the training dataset, the recipe parameters, and the model recipe to create artifact models;
evaluate the artifact models resulting from training the artificial intelligence models to form an evaluation; and
select a set of the artifact models for the artificial intelligence system using the evaluation.

11. The computer system of claim 10, the one or more processor units further executes the computer program instructions to:
deploy the artificial intelligence system to a set of target platforms.

12. The computer system of claim 11, wherein as part of deploying the artificial intelligence system, the one or more processor units further executes the computer program instructions to:
identify a set of target platforms for the artificial intelligence system;
create a set of production artificial intelligence models to form artificial intelligence system to run on the target platforms using the model recipe and the set of artifact models; and
deploy the artificial intelligence system comprising the set of production artificial intelligence models to the set of target platforms using the model recipe.

13. The computer system of claim 11, wherein the one or more processor units further executes the computer program instructions to:
monitor a number of performance metrics based on evaluation artifacts generated from training the artificial intelligence models; and
retrain the artificial intelligence system based on the number of performance metrics.

14. The computer system of claim 10, wherein as part of training the artificial intelligence models, the one or more processor units further executes the computer program instructions to:
identify resources for training the artificial intelligence models using the model recipe;
create an execution cluster based on the resources identified; and
train the artificial intelligence models in the execution cluster using the training dataset and the model recipe.

15. The computer system of claim 10, wherein as part of training the artificial intelligence models, the one or more processor units further executes the computer program instructions to:
create a project for creating the artifact models, wherein the project comprises multiple steps; and
run an experiment for the project that creates artifact models.

16. The computer system of claim 14, wherein the model recipe is selected from a group comprising a generalized model recipe and customized model recipe.

17. The computer system of claim 10, wherein the recipe parameters are selected from at least one of an application specific parameter, a learning parameter, and training level.

18. The computer system of claim 10, wherein the artificial intelligence system comprises at least one of a single artificial intelligence model intelligence model for a single asset in the assets, multiple artificial intelligence models for each asset in the assets, a single artificial intelligence model for a group of assets in the assets, or multiple artificial intelligence models for multiple assets in the assets.

19. A computer program product for generating an artificial intelligence system, the computer program product comprising a computer readable storage device having computer program instructions embodied therewith, the computer program instructions executable by a computer system to cause the computer system to:
select a model recipe for generating the artificial intelligence system for use with assets;
identify recipe parameters specified in the model recipe;
create a training dataset using the model recipe and input data;
train artificial intelligence models using the training dataset, the recipe parameters, and the model recipe to create artifact models;
evaluate the artifact models resulting from training the artificial intelligence models to form an evaluation; and
select a set of the artifact models for the artificial intelligence system using the evaluation.

20. The computer program product of claim 19, wherein the computer program instructions executable by the computer system further cause the computer system to:
deploy the artificial intelligence system to a set of target platforms.
